(19) United States
(12) Patent Application Publication
(10) Pub. No.: US 2025/0078445 A1
(43) Pub. Date: Mar. 6, 2025

(54) JUDGMENT SYSTEM, ELECTRONIC SYSTEM, JUDGMENT METHOD AND DISPLAY METHOD

(71) Applicant: REALTEK SEMICONDUCTOR CORP., Hsinchu (TW)

(72) Inventors: Chih-Yuan Koh, Hsinchu (TW); Chao-Hsun Yang, Hsinchu (TW); Shih-Tse Chen, Hsinchu (TW)

(73) Assignee: REALTEK SEMICONDUCTOR CORP., Hsinchu (TW)

(21) Appl. No.: 18/669,941

(22) Filed: May 21, 2024

(30) Foreign Application Priority Data
Aug. 30, 2023 (TW) 112132895

(51) Int. Cl. G06V 10/44; G06T 3/60; G06T 7/62

(52) U.S. Cl. CPC G06V 10/44; G06T 3/60; G06T 7/62; G06T 2207/20084; G06T 2207/30201

(57) ABSTRACT

A judgment system, an electronic system, a judgment method, and a display method are provided. The judgment method includes: receiving an image by a feature acquisition module and obtaining a first key point coordinate, a second key point coordinate, and a size of a face box of a user by the feature acquisition module based on the image; and performing following steps by a judgment module: obtaining a judgment value based on an ordinate of the first key point coordinate, an ordinate of the second key point coordinate, and a size of the face box; and sending a rotation signal in response to that the judgment value satisfies a rotation condition.

### CROSS-REFERENCE TO RELATED APPLICATION

This non-provisional application claims priority under 35 U.S.C. § 119 (a) to patent application No. 112132895 filed in Taiwan, R.O.C. on Aug. 30, 2023, the entire contents of which are hereby incorporated by reference.

### BACKGROUND

### Technical Field

The instant disclosure is related to the technical field of display method of electronic systems, especially to a technique which utilizes key points of a user in an image.

### Related Art

In recent years, many technological products are introduced to smart applications, and parts of the functions rely on the use of a camera, such as human presence detection (HPD), face recognition, gesture recognition, and gaze detection. However, according to application scenarios, there will be occasions where image rotation is needed. In this case, performance of the aforementioned technologies is often affected. Although using a sensor such as an accelerometer or a gyroscope to obtain rotation information may be helpful for improving the aforementioned issue, the judgment result of the sensor may not necessarily be beneficial for smart applications.

### SUMMARY

In view of this, some embodiments of the instant disclosure provide a judgment system, an electronic system, a judgment method, and a display method to improve current technical issue(s).

Some embodiments of the instant disclosure provide a judgment system comprising a feature acquisition module and a judgment module. The feature acquisition module is configured to receive an image and obtain a first key point coordinate, a second key point coordinate, and a size of a face box of a user based on the image. The judgment module is configured to execute following steps: obtaining a judgment value based on an ordinate of the first key point coordinate, an ordinate of the second key point coordinate, and the size of the face box; and sending a rotation signal in response to that the judgment value satisfies a rotation condition.

Some embodiments of the instant disclosure provide an electronic system comprising the aforementioned judgment system and a display module. The display module is configured to change an orientation direction of a screen-displayed content in response to that the display module receives the rotation signal.

Some embodiments of the instant disclosure provide a judgment method comprising: receiving an image by a feature acquisition module and obtaining a first key point coordinate, a second key point coordinate, and a size of a face box of a user by the feature acquisition module based on the image; and performing following steps by a judgment module: obtaining a judgment value based on an ordinate of the first key point coordinate, an ordinate of the second key point coordinate, and a size of the face box; and sending a rotation signal in response to that the judgment value satisfies a rotation condition.

Some embodiments of the instant disclosure provide a display method applying the aforementioned judgment method. The display method comprises: changing an orientation direction of a screen-displayed content by a display module in response to that the display module receives the rotation signal.

As above, the judgment system, the electronic system, the judgment method, and the display method provided by one or some embodiments of the instant disclosure take into consideration the usage of key points of a user in order to determine whether to transmit a rotation signal. As a result, the system or the method according to one or some embodiments of the instant disclosure would be suitable to cooperate with applications such as human presence detection and face recognition, where user detection is naturally needed. Through detection of the model, whether a demand for rotation is present can be learned, and therefore the system can switch to using a model corresponding to the scenario. Consequently, to achieve the applications, it would be not necessary to capture information from a sensor, and thus time cost due to calculation can be reduced.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a schematic block diagram of a judgment system according to some embodiments of the instant disclosure;

FIG. 2 illustrates a schematic operation diagram of a feature acquisition module according to some embodiments of the instant disclosure;

FIG. 3 illustrates a schematic operation diagram of a feature acquisition module according to some embodiments of the instant disclosure;

FIG. 4A illustrates a schematic block diagram of a neural network module according to some embodiments of the instant disclosure;

FIG. 4B illustrates a schematic block diagram of a feature tensor generation module according to some embodiments of the instant disclosure;

FIG. 5 illustrates a schematic block diagram of a fusion module according to some embodiments of the instant disclosure;

FIG. 6 illustrates a schematic structural block diagram of a prediction module according to some embodiments of the instant disclosure;

FIG. 7 illustrates a schematic structural block diagram of an information tensor according to some embodiments of the instant disclosure;

FIG. 8 illustrates a schematic block diagram of an electronic system according to some embodiments of the instant disclosure;

FIG. 9 illustrates a schematic operation diagram of the electronic system according to some embodiments of the instant disclosure;

FIG. 10 illustrates a schematic structural block diagram of the electronic system according to some embodiments of the instant disclosure;

FIG. 11 illustrates a flow chart of a judgment method according to some embodiments of the instant disclosure;

FIG. 12 illustrates a flow chart of a calculation of a size of a face box according to some embodiments of the instant disclosure;

FIG. 13 illustrates a flow chart of a calculation of a judgment value according to some embodiments of the instant disclosure;

FIG. 14 illustrates a flow chart of a judgment method according to some embodiments of the instant disclosure; and

FIG. 15 illustrates a flow chart of a display method according to some embodiments of the instant disclosure.

### DETAILED DESCRIPTION

The foregoing and other technical contents, features, and effects of the instant disclosure can be clearly presented below in detailed description with reference to embodiments of the accompanying drawings. Any modification to the structure, change to the proportional relationship, or adjustment on the size without affecting the effects and the objectives that can be achieved by the instant disclosure should fall within the scope of the technical content disclosed by the instant disclosure. In all drawings, identical symbols are used to denote identical or similar elements. In the instant disclosure, ordinals such as “first” or “second” are used to differentiate or refer to identical or similar elements or structures and do not necessarily imply the order of such elements in the system. It should be understood that, under some conditions or configurations, the ordinals may be used interchangeably and do not affect the implementation of the instant disclosure.

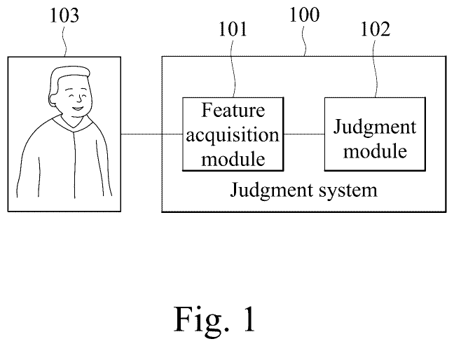

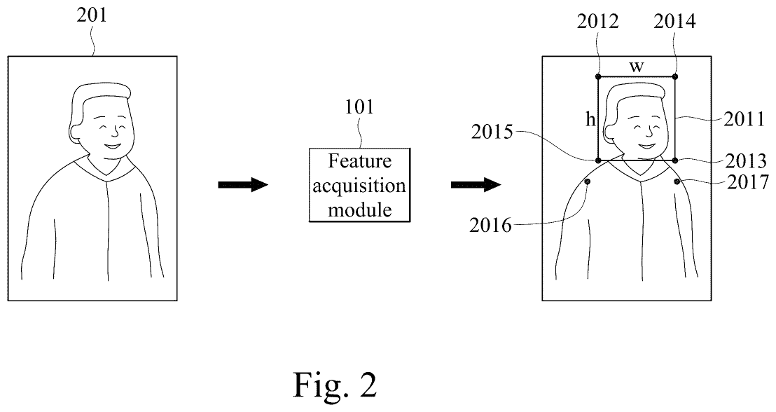

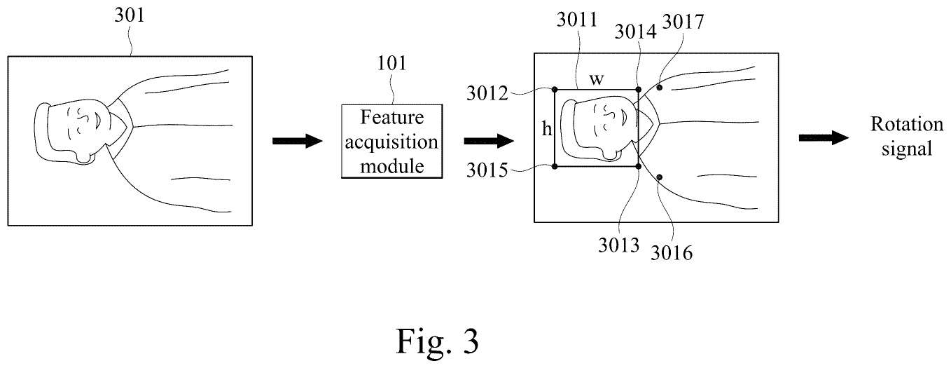

FIG. 1 illustrates a schematic block diagram of a judgment system according to some embodiments of the instant disclosure. FIG. 2 illustrates a schematic operation diagram of a feature acquisition module according to some embodiments of the instant disclosure. FIG. 3 illustrates a schematic operation diagram of the feature acquisition module according to some embodiments of the instant disclosure. Please refer to FIG. 1 through FIG. 3 at the same time. The judgment system 100 comprises a feature acquisition module 101 and a judgment module 102. The feature acquisition module 101 is configured to receive an image 103 (such as an image 201 in FIG. 2 or an image 301 in FIG. 3) and obtain a first key point coordinate (x₁, y₁) of a first key point (such as a first key point 2016 in FIG. 2 or a first key point 3016 in FIG. 3), a second key point coordinate (x₂, y₂) of a second key point (such as a second key point 2017 in FIG. 2 or a second key point 3017 in FIG. 3), and a size of a face box (such as a face box 2011 in FIG. 2 or a face box 3011 in FIG. 3) of a user based on the image 103.

It is worth illustrating that the aforementioned coordinates adopt pixel coordinates of the image 103. In other words, in some embodiments, a coordinate of a top left vertex of the image 103 is set as (0,0), a first coordinate component of the coordinate is a location counted left-to-right from the top left vertex, and a second coordinate component of the coordinate is a location counted top-to-bottom from the top left vertex.

The first component of the coordinate is referred to as an abscissa, and the second component of the coordinate is referred to as an ordinate. Consequently, the abscissas of the first key point coordinate (x₁, y₁) and the second key point coordinate (x₂, y₂) are x₁ and x₂, respectively, and the ordinates of the first key point coordinate (x₁, y₁) and the second key point coordinate (x₂, y₂) are y₁ and y₂, respectively.

In some embodiments of the instant disclosure, the first key point coordinate and the second key point coordinate are selected as two points which are symmetrical about a virtual middle line of a human body. For example, as shown in FIG. 2 and FIG. 3, the first key point is selected at a right shoulder point (such as the location indicated by the first key point 2016 in FIG. 2 or the first key point 3016 in FIG. 3), and the second key point is selected at a left shoulder point (such as the location indicated by the second key point 2017 in FIG. 2 or the second key point 3017 in FIG. 3).

In some embodiments of the instant disclosure, a size of the face box (such as the face box 2011 in FIG. 2 or the face box 3011 in FIG. 3) is selected as a height h of the face box (such as the height h of the face box denoted in FIG. 2 and FIG. 3).

The following description will illustrate with accompanying drawings the judgment method and how each module of the judgment system 100 cooperates with each other in some embodiments of the instant disclosure in detail.

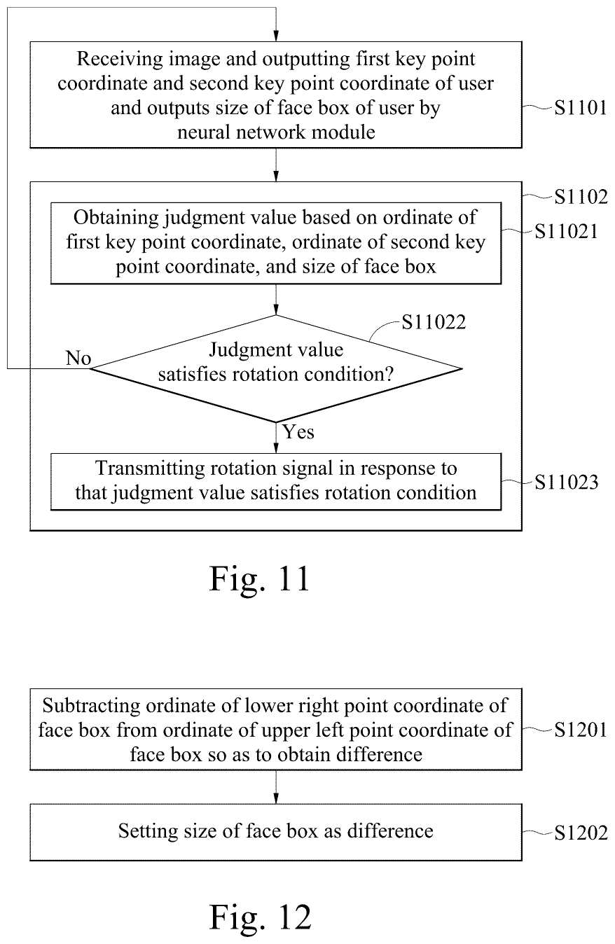

FIG. 11 illustrates a flow chart of a judgment method according to some embodiments of the instant disclosure. Please refer to FIG. 1, FIG. 2, FIG. 3, and FIG. 11 at the same time. In the embodiment shown in FIG. 11, the judgment method comprises the step S1101 and the step S1102. In the step S1101, the feature acquisition module 101 receives the image 103. Besides, the feature acquisition module 101 obtains the first key point coordinate (such as (x₁, y₁) in FIG. 2 and FIG. 3), the second key point coordinate (such as (x₂, y₂) in FIG. 2 and FIG. 3), and the size of the face box (such as the face box 2011 in FIG. 2 or the face box 3011 in FIG. 3) of the user based on the image 103. In the step S1102, the judgment module 102 executes the step S11021 and the step S11022. In the step S11021, the judgment module 102 obtains a judgment value based on the ordinate of the first key point coordinate (such as (x₁, y₁) in FIG. 2 and FIG. 3), an ordinate of the second key point coordinate (such as (x₂, y₂) in FIG. 2 and FIG. 3), and the size of the face box. In the step S11022, the judgment module 102 verifies whether the judgment value satisfies a rotation condition. In response to that the judgment module 102 verifies that the judgment value satisfies the rotation condition, the judgment module 102 executes the step S11023. In the step S11023, in response to that the judgment value satisfies the rotation condition, the judgment module 102 transmits a rotation signal. In response to that the judgment module 102 verifies that the judgment value does not satisfy the rotation condition, the judgment method returns to step S1101 to wait for the feature acquisition module 101 to receive the next image, and then continues with step S1101 and step S1102.

FIG. 12 illustrates a flow chart of a calculation of a size of a face box according to some embodiments of the instant disclosure. In some embodiments of the instant disclosure, the feature acquisition module 101 obtains an upper left coordinate of an upper left point of the face box (such as an upper left point 2012 of the face box 2011 in FIG. 2 or an upper left point 3012 of the face box 3011 in FIG. 3) and a lower right coordinate of a lower right point of the face box (such as a lower right point 2013 of the face box 2011 in FIG. 2 or a lower right point 3013 of the face box 3011 in FIG. 3) from the image 103. The step S11011 comprises the step S1201 and the step S1202. The feature acquisition module 101 obtains the size of the face box (such as the face box 2011 in FIG. 2 or the face box 3011 in FIG. 3) according to the step S1201 and the step S1202. In the step S1201, the feature acquisition module 101 subtracts the ordinate of the lower right point coordinate of the lower right point of the face box from the ordinate of the upper left point coordinate of the upper left point of the face box so as to obtain a difference. This difference is the height h of the face box. In the step S1202, the feature acquisition module 101 sets the size of the face box (such as the face box 2011 in FIG. 2 or the face box 3011 in FIG. 3) as the difference. In other words, in this embodiment, the feature acquisition module 101 takes the difference as the size of the face box.

It is worth illustrating that, in the aforementioned embodiment, the feature acquisition module 101 subtracts the ordinate of the lower right point coordinate of the face box from the ordinate of the upper left point coordinate of the face box so as to obtain the height h of the face box. Of course, in some other embodiments, the feature acquisition module 101 may also subtract the ordinate of a lower left point coordinate of the face box (such as a lower left point 2015 of the face box 2011 in FIG. 2 or a lower left point 3015 of the face box 3011 in FIG. 3) from the ordinate of an upper right point coordinate of the face box (such as an upper right point 2014 of the face box 2011 in FIG. 2 or an upper right point 3014 of the face box 3011 in FIG. 3) so as to obtain the height h of the face box, and the instant disclosure is not limited thereto.

It is also worth illustrating that, in some embodiments of the instant disclosure, the size of the face box (such as the face box 2011 in FIG. 2 or the face box 3011 in FIG. 3) is selected as a width w of the face box (such as the width w of the face box denoted in FIG. 2 and FIG. 3). The feature acquisition module 101 subtracts the abscissa of the lower left point coordinate of the face box from the abscissa of the upper right point coordinate of the face box so as to obtain the width w of the face box.

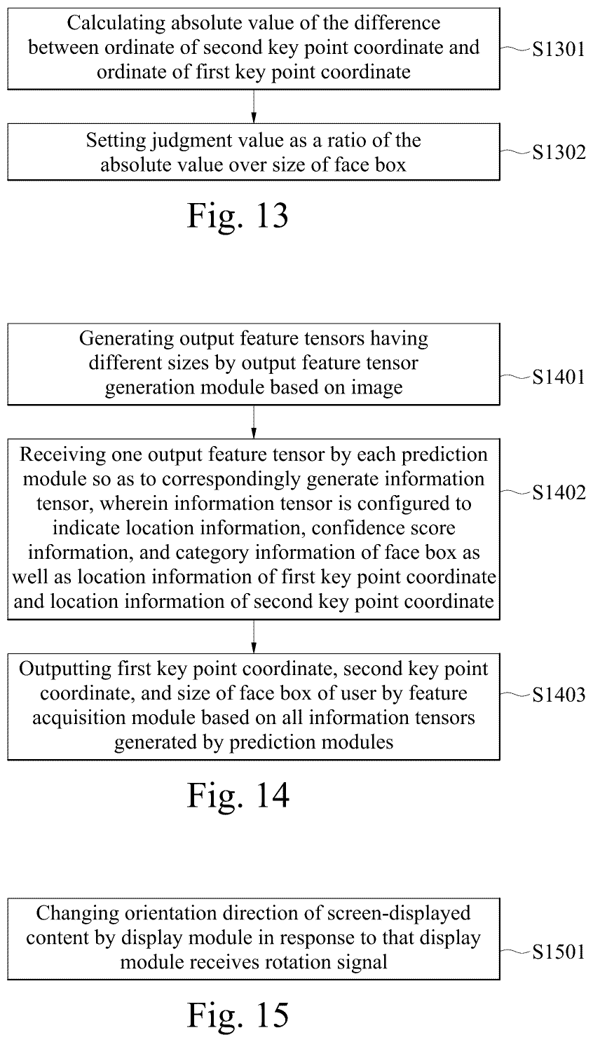

FIG. 13 illustrates a flow chart of a calculation of a judgment value according to some embodiments of the instant disclosure. Please refer to FIG. 13. In the embodiment shown in FIG. 13, the step S11021 comprises the step S1301 and the step S1302. In the step S1301, the judgment module 102 calculates an absolute value of the difference between the ordinate of the second key point coordinate (such as (x₂, y₂) in FIG. 2 and FIG. 3) and the ordinate of the first key point coordinate (such as (x₁, y₁) in FIG. 2 and FIG. 3). Taking the embodiment shown in FIG. 2 and FIG. 3 for example, the judgment module 102 calculates |y₂−y₁|. In the step S1302, the judgment module 102 sets the judgment value as a ratio of the absolute value of the difference between the ordinate of the second key point coordinate (such as (x₂, y₂) in FIG. 2 and FIG. 3) and the ordinate of the first key point coordinate (such as (x₁, y₁) in FIG. 2 and FIG. 3) over the size of the face box (such as the height h of the face box 2011 in FIG. 2 or the height h of the face box 3011 in FIG. 3). In other words, in some embodiments, the judgment module 102 sets

$$judgement value = \frac{\vert {y}_{2} - {y}_{1} \vert}{size of face box} .$$

Continuing from the embodiment shown in FIG. 13, in some embodiments of the instant disclosure, the rotation condition in the step S11022 is that the judgment value is greater than or equal to a default value.

It is worth illustrating that, in the aforementioned embodiment, the formula for the judgment value uses the size of the face box (such as the height h of the face box), the ordinate (y₁) of the first key point coordinate (such as a right shoulder point), and the ordinate (y₂) of the second key point coordinate (such as a right shoulder point). Because the first key point and the second key point are selected as two points that are symmetrical about the virtual middle line of the human body, in normal circumstances, a little difference exists between the ordinates of the first key point and the second key point (such as the left shoulder point and the right shoulder point). Therefore, the ratio of such difference over the size of the face box should be fairly small. Besides, in the aforementioned embodiment, because a ratio of the face box is close to that of a square, even if rotation is done (such as shown in FIG. 2 and FIG. 3), the height h of the face box will merely vary by a little (i.e., merely little difference exists between the height h of FIG. 2 and the height h of FIG. 3), while an obvious difference will exist between the ordinates of the first key point and the second key point (such as the left shoulder point and the right shoulder point). In this case, the ratio of such difference over the height h of the face box will apparently increase. When such ratio exceeds a threshold (such as greater than or equal to the default value), the judgment module 102 transmits a rotation signal.

The system or the method according to one or some embodiments of the instant disclosure would be especially suitable to cooperate with applications such as human presence detection and face recognition, where user detection is naturally needed. Through detection of the model, whether a demand for rotation is present can be learned, and therefore the system can switch to using a model corresponding to the scenario. Consequently, to achieve the applications, it would be not necessary to capture information from a sensor, and thus time cost due to calculation can be reduced.

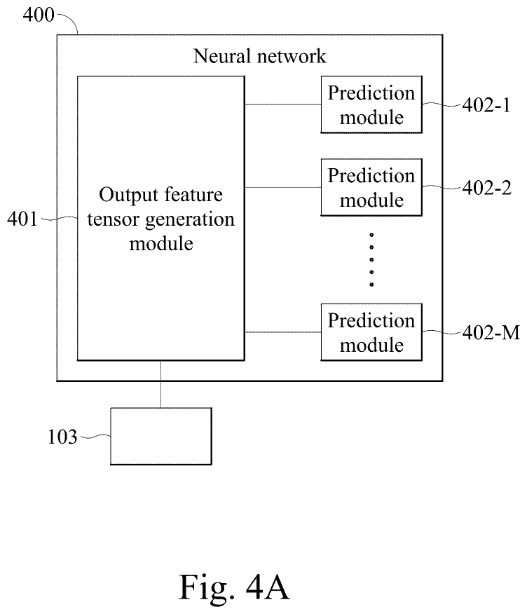

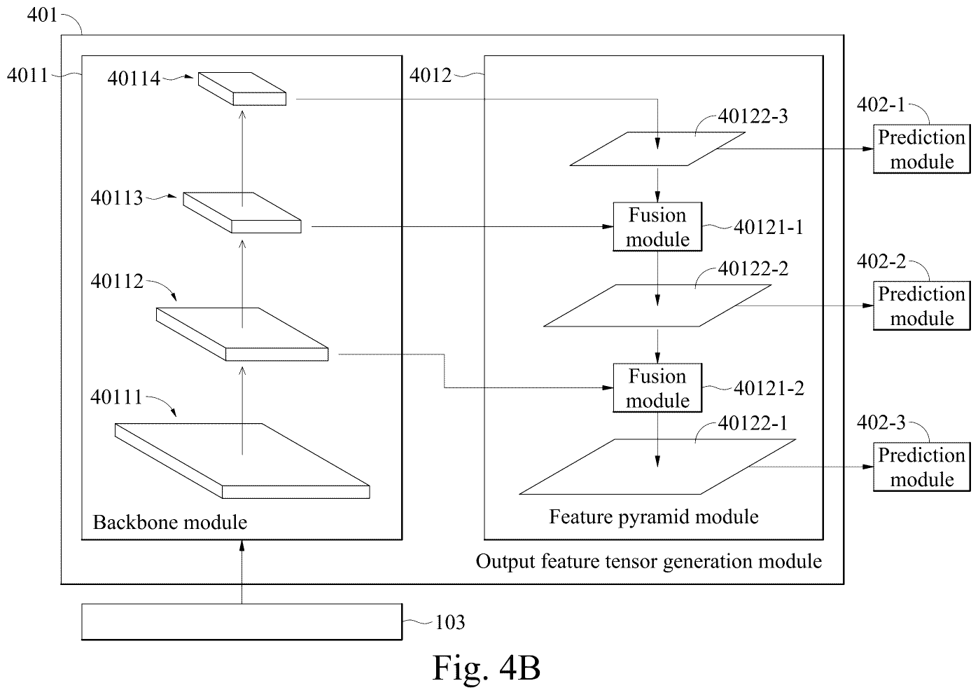

FIG. 4A illustrates a schematic block diagram of a neural network module according to some embodiments of the instant disclosure. Please refer to FIG. 1 through FIG. 3 and FIG. 4A at the same time. In some embodiments of the instant disclosure, the feature acquisition module 101 comprises a neural network module 400. The neural network module 400 is configured to receive the image 103 and output the first key point coordinate (such as (x₁, y₁) in FIG. 2 and FIG. 3) and the second key point coordinate (such as (x₂, y₂) in FIG. 2 and FIG. 3) of the user and output the size of the face box of the user. The step S1101 comprises receiving the image 103 by the neural network module 400 and outputting the first key point coordinate and the second key point coordinate of the user and outputting the size of the face box of the user by using the neural network module 400.

The following description will further illustrate various embodiments of the neural network module 400. In some embodiments of the instant disclosure, the neural network module 400 comprises an output feature tensor generation module 401 and a prediction module 402-1 through a prediction module 402-M, wherein M is an integer greater than or equal to 2. The output feature tensor generation module 401 is configured to generate a plurality of output feature tensors having different sizes based on the image 103. Each of the prediction modules 402-1 through 402-M is configured to receive a corresponding one of the output feature tensors so as to correspondingly generate an information tensor. That is, each of the prediction modules 402-1 through 402-M will generate one information tensor which corresponds to the corresponding one of the output feature tensors. The information tensor is configured to indicate a location information of the face box (such as the face box 2011 in FIG. 2 or the face box 3011 in FIG. 3), a confidence score information, and a category information as well as a location information of the first key point coordinate (such as (x₁, y₁) in FIG. 2 and FIG. 3) and a location information of the second key point coordinate (such as (x₂, y₂) in FIG. 2 and FIG. 3). The feature acquisition module 101 outputs the first key point coordinate, the second key point coordinate, and the size of the face box of the user based on all of the information tensors generated by the prediction modules 402-1 through 402-M.

FIG. 14 illustrates a flow chart of a judgment method according to some embodiments of the instant disclosure. Please refer to FIG. 14. In the embodiment shown in FIG. 14, the step S1101 comprises the step S1401 through the step S1403. In the step S1401, the output feature tensor generation module 401 generates a plurality of output feature tensors having different sizes based on the image 103. In the step S1402, each of the prediction modules 402-1 through 402-M receives a corresponding one of the output feature tensors so as to correspondingly generate an information tensor. As described above, the information tensor is configured to indicate the location information of the face box (such as the face box 2011 in FIG. 2 or the face box 3011 in FIG. 3), the confidence score information, and the category information as well as a location information of the first key point coordinate and a location information of the second key point coordinate. In the step S1403, the feature acquisition module 101 outputs the first key point coordinate, the second key point coordinate, and the size of the face box of the user based on all of the information tensors generated by the prediction modules 402-1 through 402-M.

FIG. 4B illustrates a schematic block diagram of a feature tensor generation module according to some embodiments of the instant disclosure.

Please refer to FIG. 4A and FIG. 4B at the same time. In the following description, for the sake of convenience, M=3 will be considered for illustration purposes.

The output feature tensor generation module 401 comprises a backbone module 4011 and a feature pyramid module 4012. The image 103 may be for example a tensor having dimensions of 256×256×3 or a tensor having dimensions of 256×256×1.

In some embodiments of the instant disclosure, the backbone module 4011 comprises backbone layers 40111 through 40114 having different sizes. The backbone module 4011 is configured to generate a plurality of feature tensors having different sizes based on the image 103 through the backbone layer 40111 through the backbone layer 40114, where the feature tensors have a first sequence. As shown in FIG. 4B, the feature tensors are as follows: an output tensor of the backbone layer 40112, an output tensor of the backbone layer 40113, and an output tensor of the backbone layer 41104. In this embodiment, the first sequence is an arrangement sequence of the feature tensors according to the sizes of the feature tensors, where the arrangement sequence is a big-to-small arrangement sequence. It is worth illustrating that, in this embodiment, although the backbone module 4011 merely comprises four backbone layers, a person skilled in the art may use another number of backbone layers according to demands, and the instant disclosure is not limited thereto. It is also worth illustrating that, in the embodiment shown in FIG. 4B, although the backbone layer 40111 through the backbone layer 40114 are connected to each other in series, the backbone layer 40111 through the backbone layer 40114 may also be connected to each other in series and in parallel at the same time, and the instant disclosure is not limited thereto. The feature pyramid module 4012 is configured to perform fusion on the feature tensors so as to obtain a plurality of output feature tensors.

Please refer to FIG. 4B and FIG. 14 at the same time. In some embodiments of the instant disclosure, the step S1401 comprises a first step and a second step described below. In the first step, the backbone module 4011 generates the feature tensors having different sizes based on the image through the backbone layer 40111 through the backbone layer 40114, where the feature tensors have the first sequence. Besides, the first sequence is the arrangement sequence of the feature tensors according to the sizes of the feature tensors, where the arrangement sequence is the big-to-small arrangement sequence. In the second step, the feature pyramid module 4012 performs fusion on the feature tensors (the tensors generated based on the image 103 and having different sizes and the first sequence) so as to obtain the output feature tensors.

Please refer to FIG. 4B again. In some embodiments of the instant disclosure, the feature pyramid module 4012 comprises a fusion module 40121-1 and a fusion module 40121-2. The feature pyramid module 4012 is configured to execute the following steps so as to perform fusion on the feature tensors in order to obtain the output feature tensors.

First, the feature pyramid module 4012 sets a smallest feature tensor (which is the last one of the feature tensors according to the first sequence) as an element of a temporary feature tensor set. Taking the embodiment shown in FIG. 4B as an example, the smallest feature tensor is the output tensor of the backbone layer 40114. Besides, the feature pyramid module 4012 stores the smallest feature tensor at a temporary feature tensor 40122-3 as the element of the temporary feature tensor set.

Next, the feature pyramid module 4012 performs upsampling operation on the temporary feature tensor 40122-3 through the fusion module 40121-1 so as to obtain the temporary feature tensor 40122-3, where the temporary feature tensor 40122-3 has undergone upsampling and has a same size as the size of the output tensor of the backbone layer 40113. Afterwards, the feature pyramid module 4012 performs feature fusion on the temporary feature tensor 40122-3 (which has undergone upsampling) and the output tensor of the backbone layer 40113 through the fusion module 40121-1 so as to obtain a temporary feature tensor 40122-2, where the temporary feature tensor 40122-2 has a same size as a size of an output tensor of a convolution layer of the backbone layer 40113. Next, the feature pyramid module 4012 performs feature fusion on the temporary feature tensor 40122-2 (which has undergone upsampling) and the output tensor of the convolution layer of the backbone layer 40112 through the fusion module 40121-2 so as to obtain a temporary feature tensor 40122-1, where the temporary feature tensor 40122-1 has a same size as the size of the output tensor of the convolution layer of the backbone layer 40112.

The feature pyramid module 4012 outputs the temporary feature tensor 40122-3, the temporary feature tensor 40122-2, and the temporary feature tensor 40122-1 as the output feature tensors of the feature pyramid module 4012. It is worth illustrating that, in the aforementioned embodiment, three output feature tensors having different sizes being generated is taken as an example. A person skilled in the art will be able to freely increase the number of the backbone layers of the backbone module 4011 and the number of the fusion modules of the feature pyramid module 4012 according to the foregoing description to obtain any number of different sizes of output feature tensors, and therefore the instant disclosure is not limited to three output feature tensors having different sizes being generated.

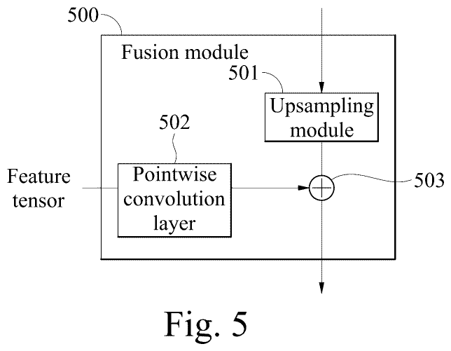

FIG. 5 illustrates a schematic block diagram of a fusion module according to some embodiments of the instant disclosure. In some embodiments of the instant disclosure, the structure of each of the fusion module 40121-1 and the fusion module 40121-2 is as illustrated for the fusion module 500. The fusion module 500 comprises an upsampling module 501, a pointwise convolution layer 502, and a pointwise addition module 503. The upsampling module 501 is configured to perform upsampling operation on an input of the upsampling module 501. In some embodiments of the instant disclosure, the upsampling operation is repeating elements at a height axis direction and a width axis direction of the input of the upsampling module 501 twice, so that the size of the input of the upsampling module 501 is converted to twice the original size. The pointwise convolution layer 502 performs pointwise convolution operation. The pointwise convolution operation is defined as performing convolution operation on a tensor with a convolution kernel having dimensions of 1×1×C, where C is the number of the channels of the input of the pointwise convolution layer 502. The pointwise addition module 503 is configured to perform pointwise addition operation on the input tensors (two in total) received by the pointwise addition module 503 so as to obtain the output tensor of the pointwise addition module 503. It is worth illustrating that, the upsampling operation adopted in this embodiment is one implementation of upsampling. Therefore, in some embodiments, the upsampling module 501 may adopt other upsampling methods, and the instant disclosure is not limited thereto.

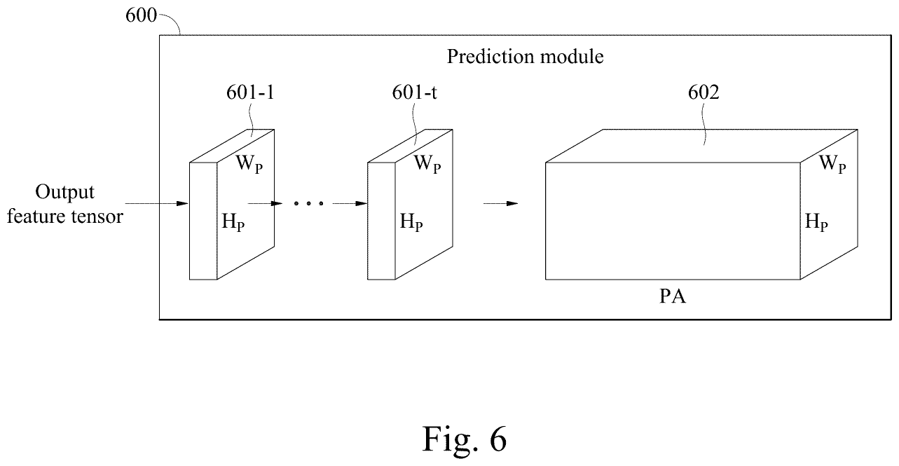

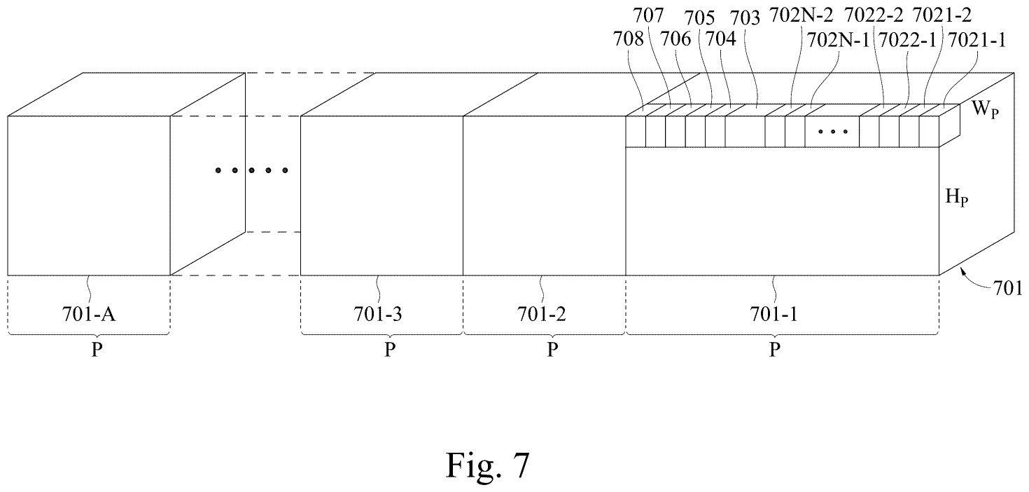

FIG. 6 illustrates a schematic structural block diagram of a prediction module according to some embodiments of the instant disclosure. FIG. 7 illustrates a schematic structural block diagram of an information tensor according to some embodiments of the instant disclosure. Please refer to FIG. 6 and FIG. 7 at the same time. In this embodiment, the structure of each of the prediction module 402-1 through the prediction module 402-3 is as illustrated for the prediction module 600. The prediction module 600 is configured to comprise a total of t convolution layers of Wₚ×Hₚ×128 (a convolution layer 601-1 through a convolution layer 601-t) and one convolution layer of Wₚ×Hₚ×PA (a convolution layer 602). In this embodiment, t is a positive integer representing the total number of the convolution layer 601-1 through the convolution layer 601-t; Wₚ and Hₚ are integers representing the dimensions of the width axis and the height axis of the convolution layers 601-1 through 601-t; A is a positive integer representing the number of anchors; and P is a positive integer. It is worth illustrating that the convolution layer denoted with Wₚ×Hₚ×128 indicates that the convolution layer performs convolution operation on the input tensor with 128 convolution kernels and concatenates the tensor which is obtained by performing convolution operation on the input tensor with the 128 convolution kernels in sequence so as to obtain the output tensor, where the number of width axes of the output tensor is Wₚ, the number of height axes of the output tensor is Hₚ, and the number of channel axes of the output tensor is 128. Such an output tensor is a tensor having dimensions of Wₚ×Hₚ×128. Similarly, a convolution layer denoted with Wₚ×Hₚ×PA indicates that the convolution layer performs convolution operation on the input tensor with PA convolution kernels to obtain a tensor. Besides, the convolution layer concatenates the tensor (which is obtained by performing convolution operation on the input tensor with the PA convolution kernels) in sequence so as to obtain the output tensor, where the number of the width axes of the output tensor is Wₚ, the number of the height axes of the output tensor is Hₚ, and the number of the channel axes is PA.

The neural network module 400 sets a total of A anchors having different sizes on the output feature tensors. In this embodiment, the value of P is 4+1+number of all categories+3, where 4 represents the number of tensor elements for describing a location coordinate of a vertex of the anchor and detecting the width and the height, 1 represents using one tensor element to describe a possibility of a detection target existing in the anchor and a level of accuracy of the anchor, and 3 represents the number of tensor elements for describing a first angle, a second angle, and a third angle of the face. The values of Wₚ, Hₚ, P, A, and t may be set by the user according to demands, and the instant disclosure is not limited thereto. It is worth illustrating that, because the sizes of the output feature tensors received by the prediction modules 402-1 through 402-M are different, the values of Wₚ and Hₚ of one of the prediction modules 402-1 through 402-M may be different from the values of Wₚ and Hₚ of another one of the prediction modules 402-1 through 402-M.

Each of the prediction modules 600 is configured to receive a corresponding one of the output feature tensors. After the output feature tensor is processed by the convolution layer 601-1 through the convolution layer 601-t of the prediction module 600 and the convolution layer 602 of the prediction module 600, one information tensor 701 can be obtained. The information tensor 701 comprises sub information tensors 701-1 through 701-A. Each of the sub information tensors 701-1 through 701-A corresponds to a corresponding one of the anchors (a total of A anchors). Each of the sub information tensors 701-1 through 701-A comprises a total of Wₚ·Hₚ vectors, and each of the vectors is a P-dimensional vector. As shown in FIG. 7, each of the P-dimensional vectors comprises tensor elements 7021-1, 7021-2, 7022-1, 7022-2, . . . , 702N-1, 702N-2, and 703 through 708, where the tensor elements 7021-1, 7021-2, 7022-1, 7022-2, . . . , 702N-1, and 702N-2 indicate the abscissas and the ordinates of N key points of the user. That is, in this embodiment, the tensor element 7021-1 indicates the abscissa of the first (1st) key point, the tensor element 7021-2 indicates the ordinate of the first (1st) key point, the tensor element 7022-1 indicates the abscissa of the second (2nd) key point, the tensor element 7022-2 indicates the ordinate of the second (2nd) key point, and so on. It is worth illustrating that, in some embodiments of the instant disclosure, N is 2. Consequently, in this embodiment, the tensor element 7021-1 indicates the abscissa of the first key point (such as the right shoulder point), the tensor element 7021-2 indicates the ordinate of the first key point (such as the right shoulder point), the tensor element 7022-1 indicates the abscissa of the second key point (such as the left shoulder point), and the tensor element 7022-2 indicates the ordinate of the second key point (such as the left shoulder point). In some embodiments of the instant disclosure, N is greater than 2. Consequently, in this embodiment, the tensor elements 7021-1, 7021-2, 7022-1, 7022-2, . . . , 702N-1, and 702N-2, comprises the abscissas and the ordinates of the first key point and the second key point (such as the left should point and the right should point).

The tensor element 703 comprises a plurality of sub tensor elements. Each of the sub tensor elements of the tensor element 703 indicates a possibility of an object in the anchor belonging to each of the categories. The tensor element 704 indicates the confidence score. The confidence score represents the possibility of a detection target existing in the anchor and a level of accuracy of the anchor. The tensor element 705 indicates the height of the anchor. The tensor element 706 indicates the width of the anchor. The tensor element 707 and the tensor element 708 indicate an anchor coordinate. The tensor elements 7021-1, 7021-2, 7022-1, 7022-2, . . . , 702N-1, and 702N-2 indicate the abscissas and the ordinates of N key points of the user (including the first key point and the second key point of the user). The anchor coordinate, the height of the anchor, and the width of the anchor are the location information of the face box. The possibility of the object in the anchor belonging to each of the categories is the category information. The confidence score is the confidence score information. In this embodiment, the N key points of the user (including the first key point and the second key point of the user) are the locations of the user which the feature acquisition module 101 was preset to extract from the image 103 (such as the right shoulder point and the left shoulder point).

The feature acquisition module 101 integrates all information tensors generated by the prediction modules 402-1 through 402-M and is able to obtain the abscissas and the ordinates of the N key points of the user (including the first key point and the second key point of the user). Next, the feature acquisition module 101 outputs the abscissas and the ordinates of one or more of the key points (such as the right shoulder point and the left shoulder point of the user) which are used for later processing.

The feature acquisition module 101 integrates all information tensors generated by the prediction modules 402-1 through 402-M and is also able to obtain the location and the category of the face box. The feature acquisition module 101 may directly calculate the height h and the width w of the face box based on information regarding the height of the anchor and the width of the anchor. The feature acquisition module 101 may also first calculate the four vertexes of the face box (such as the upper left point 2012, the lower right point 2013, the upper right point 2014, and the lower left point 2015 of the face box in 2011 of FIG. 2 or the upper left point 3012, the lower right point 3013, the upper right point 3014, and the lower left point 3015 of the face box in 3011 of FIG. 3) and then calculate the height h or the width w of the face box.

It is worth illustrating that, in this embodiment, although the content indicated by each tensor element of the P-dimensional vector is arranged as described above, the arrangement sequence of the content indicated by each tensor element of the P-dimensional vector is not limited thereto.

It is worth illustrating that, upon training the neural network module 400 of the embodiments shown in FIG. 4A, FIG. 4B, and FIG. 5 through FIG. 7, by adding data of the abscissas and the ordinates of N key points (including the first key point and the second key point of the user) into the training set and then training the neural network module 400 using the training method of object detection model, the neural network module 400 after training can be obtained.

In the embodiment shown in FIG. 4A, FIG. 4B, and FIG. 5 through FIG. 7, based on all information tensors generated by the prediction modules 402-1 through 402-M, the neural network module 400 can obtain the location and the object category of the object (the face box in the aforementioned embodiment) at the same time. In other words, in this embodiment, one neural network can detect the location of the object and identify the object at the same time. Such structure and method are called a one-stage object detection. In the technical field of the instant disclosure, the prediction module 402-1 through the prediction module 402-M are referred to as network heads. The prediction module 402-1 through the prediction module 402-M disclosed in the aforementioned embodiments may replace network heads of other one-stage object detection model, so that the aforementioned other one-stage object detection models can output the location information, the confidence score information, the category information of the face box (such as the face box 2011 of FIG. 2 or the face box 3011 of FIG. 3) as well as the location information of the first key point coordinate and the location information of the second key point coordinate. For example, the prediction module 402-1 through the prediction module 402-M disclosed in the aforementioned embodiments may be used to replace the network heads of a YOLO model. The instant disclosure is not limited to using the aforementioned backbone module 4011 and the feature pyramid module 4012.

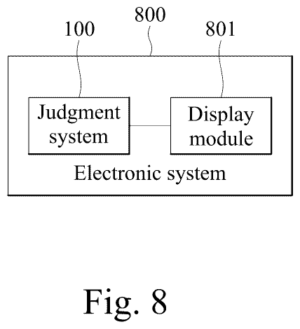

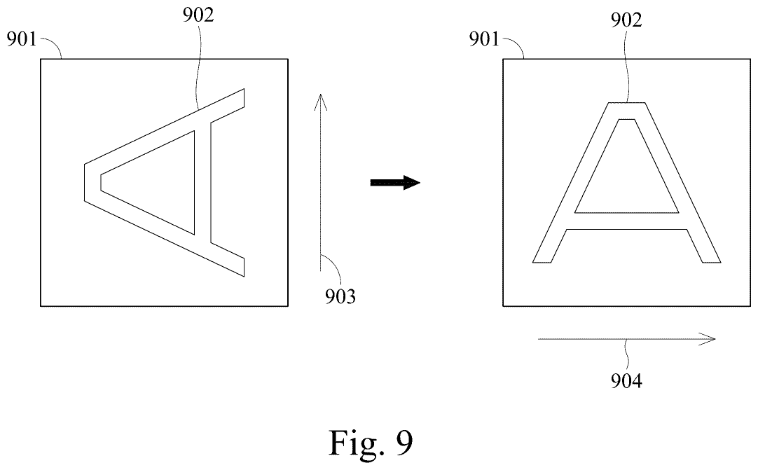

FIG. 8 illustrates a schematic block diagram of an electronic system according to some embodiments of the instant disclosure. FIG. 9 illustrates a schematic operation diagram of the electronic system according to some embodiments of the instant disclosure. Please refer to FIG. 8 and FIG. 9 at the same time. The electronic system 800 comprises the judgment system 100 described in the aforementioned embodiment and a display module 801. The display module 801 is configured to change an orientation direction of a screen-displayed content 902 in response to that the display module 801 receives the rotation signal transmitted but the judgment system 100. In this embodiment, the orientation direction of the screen-displayed content 902 refers to a direction in which the display module 901 displays the screen-displayed content 902 on a screen.

Taking the embodiment shown in FIG. 9 as an example, the display module 801 initially displays the screen-displayed content 902 in an orientation direction 903 on a screen 901. When the display module 801 receives the rotation signal transmitted by the judgment system 100, the display module 801 changes the orientation direction of the screen-displayed content 902, and thus the display module displays the screen-displayed content 902 in an orientation direction 904 on the screen 901.

The following description will illustrate with accompanying drawings a display method and how each module of the electronic system 800 cooperates with each other in some embodiments of the instant disclosure in detail. FIG. 15 illustrates a flow chart of a display method according to some embodiments of the instant disclosure. Please refer to FIG. 8 and FIG. 15 at the same time. In the embodiment shown in FIG. 15, the display method comprises the step S1501. In the step S1501, the display module 801 changes the orientation direction of the screen-displayed content 901 (such as from the orientation direction 903 to the orientation direction 904) in response to that the display module 801 receives the rotation signal.

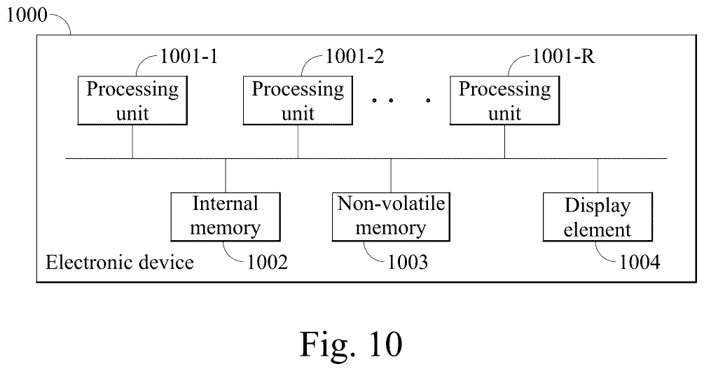

FIG. 10 illustrates a schematic structural block diagram of the electronic system according to some embodiments of the instant disclosure. As shown in FIG. 10, on a hardware level, an electronic device 1000 comprises processing units 1001-1 through 1001-R, where R is a positive integer. The electronic device 1000 comprises an internal memory 1002, a non-volatile memory 1003, and a display element 1004. The internal memory 1002 may be for example a random access memory (RAM). The non-volatile memory 1003 may be for example at least one magnetic disk memory. The display element 1004 may be for example a liquid crystal display, a plasma display, a computer display (for example, a variable graphics array (VGA) display, a super VGA display or a cathode ray tube display), or a display device of another similar type, but the instant disclosure is not limited thereto. Of course, the electronic device 1000 may also comprise hardware needed by other functions.

The internal memory 1002 and the non-volatile memory 1003 are adapted to store programs. The programs may include codes, and the codes include computer operation instructions. The internal memory 1002 and the non-volatile memory 1003 provide instructions and data for the processing units 1001-1 through 1001-R. The processing units 1001-1 through 1001-R read corresponding computer programs from the non-volatile memory 1003 to the internal memory 1002 and then execute the computer programs. Such process forms the judgment system 100 and the electronic system 800 on a logical level. The processing units 1001-1 through 1001-R are specifically used to perform the steps shown in FIG. 11 through FIG. 15. Of course, in some embodiments, each module of the judgment system 100 and the electronic system 800 may also be implemented using hardware, and the instant disclosure is not limited thereto. The display element 1004 may comprise the aforementioned screen 901.

The processing units 1001-1 through 1001-R may be an integrated circuit chip with signal processing capability. During implementation, the methods and steps disclosed in the foregoing embodiments may be achieved by the integrated logic circuit of the hardware in the processing units 1001-1 through 1001-R or software instructions. The processing units 1001-1 through 1001-R may be general purpose processors, such as central processing units (CPUs), tensor processing units, digital signal processors (DSPs), application specific integrated circuits (ASICs), field-programmable gate arrays (FPGAS,) or other programmable logic devices, and the processing units 1001-1 through 1001-R can implement or perform the methods and steps disclosed in the foregoing embodiments.

Examples of storage media of a computer include, but are not limited to, a phase-change memory (PRAM), a static random access memory (SRAM), a dynamic random access memory (DRAM), other types of random access memories (RAMs), a read-only memory (ROM), an electrically erasable programmable read-only memory (EEPROM), a flash memory, other internal memory technologies, a compact disc read-only memory (CD-ROM), a digital versatile disc (DVD), other optical storages, a cassette tape, a tape drive, other magnetic storage device, or other non-transmission media, and the storage medium can be used to store information that can be accessed by a computing device. According to the definition in the instant disclosure, the computer readable medium excludes a transitory medium such as modulated data signal and carrier wave.

As above, the judgment system, the electronic system, the judgment method, and the display method provided by one or some embodiments of the instant disclosure take into consideration the usage of key points of a user in order to determine whether to transmit a rotation signal. As a result, the system or the method according to one or some embodiments of the instant disclosure would be suitable to cooperate with applications such as human presence detection and face recognition, where user detection is naturally needed. Through detection of the model, whether a demand for rotation is present can be learned, and therefore the system can switch to using a model corresponding to the scenario. Consequently, to achieve the applications, it would be not necessary to capture information from a sensor, and thus time cost due to calculation can be reduced.

Although the technical context of the instant disclosure has been disclosed with the preferred embodiments above, the embodiments are not meant to limit the instant disclosure. Any adjustment and retouch done by any person skill in the art without deviating from the spirit of the instant disclosure shall be covered by the scope of the instant disclosure. Therefore, the protected scope of the instant disclosure shall be defined by the attached claims.

What is claimed is:

1. A judgment system comprising:
a feature acquisition module configured to receive an image and obtain a first key point coordinate, a second key point coordinate, and a size of a face box of a user based on the image; and
a judgment module configured to execute following steps:
(a) obtaining a judgment value based on an ordinate of the first key point coordinate, an ordinate of the second key point coordinate, and the size of the face box; and
(b) sending a rotation signal in response to that the judgment value satisfies a rotation condition.

2. The judgment system according to claim 1, wherein the first key point coordinate is a coordinate of a right shoulder point of the user, and the second key point coordinate is a coordinate of a left shoulder point of the user.

3. The judgment system according to claim 1, wherein the feature acquisition module is configured to obtain the size of the face box based on following steps:
subtracting an ordinate of a lower right point coordinate of the face box from an ordinate of an upper left point coordinate of the face box so as to obtain a difference; and
setting the size of the face box as the difference.

4. The judgment system according to claim 1, wherein the step (a) comprises:
calculating an absolute value of a difference between the ordinate of the second key point coordinate and the ordinate of the first key point coordinate; and
setting the judgment value as a ratio of the absolute value of the difference over the size of the face box.

5. The judgment system according to claim 4, wherein the rotation condition is that the judgment value is greater than or equal to a default value.

6. The judgment system according to claim 1, wherein the feature acquisition module comprises a neural network module, and the neural network module is configured to receive the image and output the first key point coordinate and the second key point coordinate of the user and output the size of the face box of the user.

7. The judgment system according to claim 6, wherein the neural network module comprises an output feature tensor generation module and a plurality of prediction modules, and the output feature tensor generation module is configured to generate a plurality of output feature tensors having different sizes based on the image; each of the prediction modules is configured to receive a corresponding one of the output feature tensors so as to correspondingly generate an information tensor which corresponds to the corresponding one of the output feature tensors; the information tensor is configured to indicate a location information of the face box, a confidence score information, and a category information as well as a location information of the first key point coordinate and a location information of the second key point coordinate; and the feature acquisition module outputs the first key point coordinate, the second key point coordinate, and the size of the face box of the user based on all of the information tensors generated by the prediction modules.

8. An electronic system having the judgment system according to claim 1, comprising:
a display module configured to change an orientation direction of a screen-displayed content in response to that the display module receives the rotation signal.

9. A judgment method, comprising:
(a) receiving an image by a feature acquisition module and obtaining a first key point coordinate, a second key point coordinate, and a size of a face box of a user by the feature acquisition module based on the image; and
(b) performing following steps by the judgment module:
(b1) obtaining a judgment value based on an ordinate of the first key point coordinate, an ordinate of the second key point coordinate, and a size of the face box; and
(b2) sending a rotation signal in response to that the judgment value satisfies a rotation condition.

10. The judgment method according to claim 9, wherein the first key point coordinate is a coordinate of a right shoulder point of the user, and the second key point coordinate is a coordinate of a left shoulder point of the user.

11. The judgment method according to claim 9, wherein the step (a) comprises performing following steps by the feature acquisition module so as to obtain the size of the face box:
subtracting an ordinate of a lower right point coordinate of the face box from an ordinate of an upper left point coordinate of the face box so as to obtain a difference; and
setting the size of the face box as the difference.

12. The judgment method according to claim 9, wherein the step (b1) comprises:
calculating an absolute value of a difference between the ordinate of the second key point coordinate and the ordinate of the first key point coordinate; and
setting the judgment value as a ratio of the absolute value of the difference over the size of the face box.

13. The judgment method according to claim 12, wherein the rotation condition is that the judgment value is greater than or equal to a default value.

14. The judgment method according to claim 9, wherein the feature acquisition module comprises a neural network module, and the step (a) comprises:
(a1) receiving the image and outputting the first key point coordinate and the second key point coordinate of the user and outputting the size of the face box of the user by the neural network module.

15. The judgment method according to claim 14, wherein the neural network module comprises an output feature tensor generation module and a plurality of prediction modules, and the step (a1) comprises:
(a11) generating a plurality of output feature tensors having different sizes by the output feature tensor generation module based on the image;
(a12) receiving a corresponding one of the output feature tensors by each of the prediction modules so as to correspondingly generate an information tensor which corresponds to the corresponding one of the output feature tensors, wherein the information tensor is configured to indicate a location information of the face box, a confidence score information, and a category information as well as a location information of the first key point coordinate and a location information of the second key point coordinate; and
(a13) outputting the first key point coordinate, the second key point coordinate and the size of the face box of the user by the feature acquisition module based on all of the information tensors generated by the prediction modules.

16. A display method applying the judgment method according to claim 9, comprising:
changing an orientation direction of a screen-displayed content by a display module in response to that the display module receives the rotation signal.
